(19) United States
(12) Patent Application Publication
(10) Pub. No.: US 2004/0088182 A1
(43) Pub. Date: May 6, 2004

(54) "No 1st Cost List" is a privately owned public internet interface for universal information exchange that uses disagreement dialogues to identify any questions and disagreements about the information and goods & services exchanged through the interface

(76) Inventors: Daniel B. Alter, Seattle, WA (US); Margaret Milanowski, Seattle, WA (US)

Correspondence Address: Daniel B. Alter, 635 NW 82nd ST., Seattle, WA, 98117, US

(21) Appl. No.: 10/423,215

(22) Filed: Apr. 25, 2003

Related U.S. Application Data
(60) Provisional application No. 60/376,335, filed on Apr. 26, 2002.

(51) Int. Cl. G06F 17/60

(52) U.S. Cl. 705/1

(57) ABSTRACT

This RPA explains this tools scientific background and purpose and it outlines the historical and personal scientific paths that led to the necessity for this invention. It rests on this scientific requirement: True science requires one place where all scientists can meet to disagree on an equal basis. Such a place can exist in theory as described in the “theoretical Premise” section. The RPA outlines the reasons establishments and insiders have resisted such an idea and how they go about it. The RPA shows that mankind has unconsciously been trying build such a place by our building of more and more sophisticated marketplaces. The RPA describes this tools requirements, specifications, advantages, embodiments, and implications; which explain how and why a universal scientific information exchange must work, in order to identify all questions and disagreements about anything exchanged through the Interface.

### CROSS-REFERENCES TO RELATED APPLICATIONS

not applicable

### BACKGROUND—FIELD OF INVENTION

Open to the public universal scientific information exchanges.

Real scientists must want a place where we all can meet to disagree on an equal basis. This want is implied by the method required by the objective purpose of science; which is to discover and create a perfect logical picture of reality that we can verify by (measures of cause and effect we all can see used=objective). We call these logical structures theory(s).

Therefore, logical and observations discrepancies are necessarily what we must use to improve theories with. Since scientifically acquired knowledge is for all of us, this requires a place where all possible observers can disagree with each other on an equal basis. this is not how it works in science now.

The theoretical basis for this invention rises out of neo-classical economic theory. This theory's framework of analysis describes logically how any possible kind of ‘affect’ impacts the Quantity of Goods and Services exchanged. We can use this theory to define what constraints and physical requirements are needed to build an optimal “Marketplace” for all possible kinds of exchanges over an Internet. Fundamentally these constraints imply that a single physical place can exist that is common to all exchanges.

Theoretical Premise: It can be shown that in a conserved system like an Internet with a finite number of nodes(users) at any time; then there can only be One place where All possible users can meet to Disagree at Any one time, about anything expressed with symbols. e.g. a central switching point in a phone system.

### BACKGROUND—DESCRIPTION OF PRIOR ART

The problem: Since time immemorial mankind has unconsciously sought to create a common single meeting place open 24/7 to exchange information and ideas, resolve disagreements, and to exchange all other goods and services from anywhere any of us might be, instantly.

With an Internet, just such a single place where all of us can meet simultaneously to conduct exchanges becomes possible. All that we need to consciously know to invent this place, is what the one thing is that can be common to both sides of an exchange of anything: a disagreement or question about it between the parties to the exchange.

The concept of a common to all meeting place to resolve problems and exchange goods and services is as old as organized societies. In small tribal societies all could meet in the ‘town square’. For larger societies these meetings started with annual or seasonal markets or fairs and over time evolved into markets open year round.

Examples of our evolving attempts to build one place we can all meet for exchange range from tribal councils, town halls, legislatures, the NASDAQ, e-bay, swap meets, the Nifty Nickel, Yellow Pages, Internet forums, scientific journals, legislatures, and so on.

Political meeting places naturally evolved from the public councils of a tribe. The ancient Greek public square where all citizens could meet to discuss and vote on public problems is an example. The New England town meetings are another example.

These political meeting places all had major structural problems. In all of these examples, access was restricted to a small group of privileged people called citizens. They had to rely on essentially face to face contacts. Naturally, those best at small group discussions dominated.

The next problem was that there literally could be no real accurate permanent record of what was said, instead people had to rely on their fallible memories. Even with writing, the best we could do was shorthand notes made by a secretary. As the Greeks learned, without an accurate record, large groups of people were easily swayed by demagogues and sophists who worked for special interests. With no accurate records, facts and memories could easily be twisted to the advantage of the powerful who had learned from experience to avoid open disagreements.

Suppressing disagreements about the terms of exchange in markets for physical Goods & Services meant such markets would not survive. So, over time with the evolution of formal marketplaces like the NYSE and our present commodity markets, marketplaces necessarily began to reflect some of the logical characteristics of an ideal meeting place for exchange, i.e. a single place where all participants had equal access to the same information affecting these exchanges at the same time, e.g. prices. The problem here was that simultaneity meant that publishing had to be done in a limited physical space so all participants could see and hear one another at the same time.

Now with the growth of the Internet, the potential to create a true marketplace for ideas has become possible. For example, traders on the NASDAQ conduct and record their trades from anywhere in the world. The NASDAQ is just a computerized clearinghouse for recording the terms of exchange by NASDAQ traders of securities from anywhere. The NASDAQ can do this because all parties to its trades can receive notice of trades simultaneously using modern telecommunications.

Exchanging pre-defined goods and services is simple however, compared to exchanging scientific, political, social and other ideas and information. For example, for political discussions we have evolved inconvenient public meetings, conventions, elected representatives to legislatures, and open to the public proposal techniques for citizens to put referendum and initiatives to a vote.

However, putting a referendum or an initiative on the ballot is not easy. A single person, small group, or even relatively large group with a “valid complaint or idea” will find out that it is very costly in time and money to be heard. This cost, by inspection, eliminates a large number of proposals. Often the gain is not worth the cost.

The reason insiders in political, business, and scientific arenas want to block objections to their behavior, policies, and ideas is simple. It is against their personal or group interests. They block disagreements by using three basic techniques:

First, members of establishments see, hear, and speak no evil about each others mistakes and crimes=ignore disagreements with what they do and say; or when they must respond, they change the subject; or when pushed, they call you names.

Second, they establish expensive, time consuming, multi-step procedures to winnow out the vast majority of objections, e.g. public hearings held at times and places where only paid lobbyists can afford to attend.

Third, there are the pushy ones, who can use all forms of verbal and physical intimidation like getting you fired, physical threats, beatings, and up to murder.

The three reasons they get away with this in public forums are simple:

First, all sides of an issue want to win, so they do not want to explicitly and willingly identify what the other side is disagreeing with them about

Second, there is no easy to use central public place to record disagreements with insiders or others. With no central public place to record objections on a permanent public record, insiders don't have to respond and so they don't. Its human self interest in action.

Third, no one points out these tactics as I just did above in public. It is necessary to explain what a not do is=avoiding identifying disagreements, before you can show or point out to others what these tactics are when they are being used.

Minimizing open disagreements is basic human nature, we are social animals who like to be liked. This makes it especially easy for those who control the “forum” involved, to automatically ignore you, talk over you, or change the subject. Unconsciously, we feel we have done something wrong. Once you become aware of the tactics, you get over it.

What is wrong with the way the Internet is used now to conduct public discussions?

Its how public chat rooms and forums are controlled. They use many of the same techniques described above to avoid resolving disagreements. In them, the users are usually anonymous and there is, in my experience, no real verification of who anyone really is. While these “discussions” are usually moderated, no one ever has to reach an agreement to agree or disagree in them. Further, there are almost always exclusionary rules that can be arbitrarily applied by the owners or moderators of these forums to those who are “disagreeable”. These forums have no Rules of Response.

Why did Daniel B. Alter invent this No 1st Cost List?

The path to this invention started when I made a fundamental discovery back in 1984. I was told in private I was right, but they would not help me publish. This answer to a great question would upset a lot of establishment applecarts. When I tried to publish, I was blocked by an anonymous referee. Above all, science is not done anonymously. I got mad and decided I could figure out a way to make them talk to me in public.

I am a scientist. Science is for all of us. Its purpose is to create theory(s) that perfectly describe reality in terms of cause and effect. A theory is a logical structure ordered by the logical premise of cause and effect. We try to match this theory to reality perfectly by going out and testing our theoretical predictions by using fundamental measures of cause and effect we all can see used.

Scientists first field of interest is where we are not explaining reality perfectly with theory. A very large area indeed! So the question becomes, how do we go about explaining what we do not yet understand? The answer explains why explicitly recognizing logical and observational discrepancies to our theories=(publicly identifying disagreements with them) is so important?

Purpose defines methodology. This means to create good theories we must use this method:

(a) Observe the area we don't understand.

(b) Formulate an idea to explain the phenomena in terms of measures of cause and effect we all can see used

(c) Make some measurable predictions. Your best guess.

(d) Measure=test your predictions.

(e) Then use the difference between the measurements you predicted and the ones you actually got (logical and observational discrepancies), to change the logical structure of your theory for the better.

Simple isn't it. All real scientists have to do is make lots of wrong predictions and admit them publicly to arrive at a perfect theory. Present people who call themselves scientists do not like to talk in public about their mistakes; in fact, they almost never admit their theories are wrong. Yet theoretical advances only come out of admitting when your present theories are mistaken. The faster this happens the better, which means doing it in PUBLIC.

I decided that the fundamental reason establishment scientists can get away with not admitting publicly when their theories are wrong, is that there was no public place outside their control for such disagreements to be registered. I deduced that it was theoretically possible for a single common place we could all meet to publicly disagree or conduct all other possible exchanges when an Internet existed. The result is the No 1st Cost List. Nothing like it has ever existed before by inspection.

### SUMMARY

There does not exist at present, a single place outside the control of special interests, where any of all of us can register disagreements with one another and track how we resolve them.

Such a universal information exchange has never existed before; because it was impossible to build without an Internet or the the discovery of the theoretical premise that defines that it can logically exist. Once an Internet is built, then an open to all public place for public disagreements can be invented and built.

The No 1st Cost List (N1CL) is an open to all on an equal basis privately owned Public Internet Interface for universal information exchange. It uses explicit agreements to Rules of Response that cause its users to identify all possible questions and disagreements expressed with symbols through the interface. The result is an universal information exchange that can be used by all of us as a common meeting point from anywhere we can reach in the universe to exchange and verify information, answer questions, resolve disagreements, and exchange any combination of goods and services.

### OBJECTS AND ADVANTAGES

Accordingly, besides the objects and advantages of the Public Disagreement Dialogue Internet Interface described above, several objects and advantages are:

(a) a permanent public written record of what members say, sell, or solicit through the interface and of the Dialogues that result;

(b) it identifies which people, businesses, and organizations will stand behind what they say, sell, or solicit anywhere on the planet;

(c) a unique permanent privately owned public address, which;

(d) creates a universal message tree where we can contact one another 24/7 from anywhere that the Internet reaches;

(e) creates a relatively safe way to criticize powerful people as we do not need to know where you are to verify who you are;

(f) a clear sharp boundary between public and private exchanges of information which allows frank dialogues before committing to a public record;

(g) it identifies logical observational discrepancies in scientific theories;

(h) it enables us to create software that remembers your answers to questions so you only have to answer a question once;

(i) businesses and organizations have a single place where people can go to ask questions and get answers 24/7;

(j) a new kind of newspaper whose reporters have agreed to answer questions from anyone about what they report;

(k) a new way to resolve publicly identified disagreements by letting anyone submit proposals to resolve disagreements to a paid public vote, proceeds divided up among the winners by pre-determined formula;

(I) it identifies public problems early while they are still small.

Further objects and advantages will come out of using this interface. For example, it suggests some economical ways of controlling spam like only accepting solicitations from N1CL members and/or requiring that there be a one click un-subscribe button. With time and experience many new and novel uses will appear.

### FIGURES: WEB PAGES & SPECIFICATIONS FROM PPA

Web page 1a, 1b, show the home page.

Web page 2 shows the agreements and rules of response from our test web site.

PPA: on pages 2, 3, 4 of our PPA is a list of logical and physical specifications.

We chose not to retype them separately to show that the N1CL test web site substantially reflects the outline in the PPA.

There will be a number of additional features to the web site but they are not crucial to its fundamental operation and need not be listed here.

### REFERENCES TO WEB PAGE BUTTONS AND THE SPECIFICATIONS

Web page Buttons will be referred to by label on them and location on page, i.e. Web page 1b, button “Agreements & Contracts”, second button from top on left.

Specifications will be referred to by PPA page and number, e.g. PPA page 3, #1; or page 2, under the heading, “What must be done to create this “List”?”, para 1.

### DESCRIPTION—PAGES 1, 2, 3 AND 4—PREFERRED EMBODIMENT

First you need a web site with registered domain names. Ours are: No First Cost List.com and .net, No 1st Cost List.com and .net, nfcl.net, n1cl.net and.com.

The heart of the No 1st Cost List is the list of people who will agree to answer questions from anyone about what they say, sell, or solicit through the N1CL interface, and the agreement to respond to one another until they reach an agreement to agree or disagree. The process described below outlines how we use our Internet web-site to embody this Public Disagreement Dialogue Interface so that our members can respond fairly and economically to the questions they receive.

A preferred embodiment is demonstrated by web pages 1a, 1b that show the N1CL home page. On it are buttons that lead new users and members through sign-up procedures that take them through the agreements and application for membership. For example, The big top button labeled as “New Questioners register here” on web page 1a, takes any new potential user through a log-in script that IDs them(valid e-mail address required only); has them sign the dialogue agreement, and then asks them for which member they want to ask a question of. Once they name a member, they are led to the member's dialogues and asked to cite specifically from the dialogue what the question is about. Once the question is recorded, both the member and the questioner will receive an e-mail confirmation of the question and a restatement of the Rules of Response.

After a member receives a question which is listed on his public file, they have 24 hours to answer the question after downloading. Once downloaded, the questioner will receive an e-mail notification of downloading.

The member may not cherry pick questions. They must answer them in the order received, except that when downloading more than one at a time, then they have 24 hours to respond in any order to the questions downloaded. Any response including “I need more time.”, with the time limit set explicitly by the member is fine. If the time limit is considered unreasonable by the questioner, then there is an appeal mechanism both parties have agreed to,;the loser of an appeal pays costs. By inspection, anyone who agrees to answer questions from anyone will exhibit good will or they will quickly lose their reputation for veracity.

Every other function the interface must perform is deduced from the above functions. Most of them are, (We are sure during Beta testing that someone will notice anything essential left out.):

(a) central file, each member and user must have their own personal file where copies of all their interactions through the list are kept, e.g. a copy of all e-mail notices and reminders;

(b) permanent public memory, both user files and the Public Record require a database to remember what we say to one another;

(c) members must be assigned a unique Public address,

(d) using self-selected ID characteristics;

(e) complete free speech: No prior restraint of any kind except where legally compelled. You are saying it on the record; thus you are completely responsible for what you say. We provide an accurate record; you provide the speech.

(f) anonymous physical location: We do not need to know where you are to verify who you are when you have permanent public address on the Internet. Criticism can be dangerous, especially of bad leaders;

(g) privately owned public address: This requirement is directly implied by function (f);

(h) privately owned by its members: This prevents any government or other organization from blocking criticism of itself or those people or organizations it favors;

(i) members can not sell their membership or public address in the N1CL, or the No1st Cost List;

(J) automatic verification and notification of what is placed on the N1CL record to the parties involved in an exchange or addressed;

(k) automatic software notifications to remind you of where you are in dialogues and in any other necessary places required to use the N1CL;

(I) automatic enforcement and notification of Rules of Response, e.g. when you don't respond in time you can't use the list for anything else until you do respond.

(m) develop a database that remembers your answers to questions;

(n) classified advertising section; see “Classified Open to All” button, bottom column of buttons, 3rd from top on web page 1a;

(o) secure, private file space owned by members; (to do)

(p) value added for members; members can see changes to N1CL in real time, non-members after a 24 hour delay unless they pay for the “news”,. Also members can have web-sites on N1CL (business or private), non-members can only list in classified;

(q) legal staff paid from earmarked revenues to enforce N1CL agreements and default fund, and to protect our rights to free speech everywhere, see application.

Embodying these functions in an web site interface is complex. Since we are still pre-beta they will require testing to work the bugs out. By the time you begin to examine this application most features listed above should be working, see n1cl.net. So far we have not run into any problems with getting programmers and software designers to understand and embody the specifications as written.

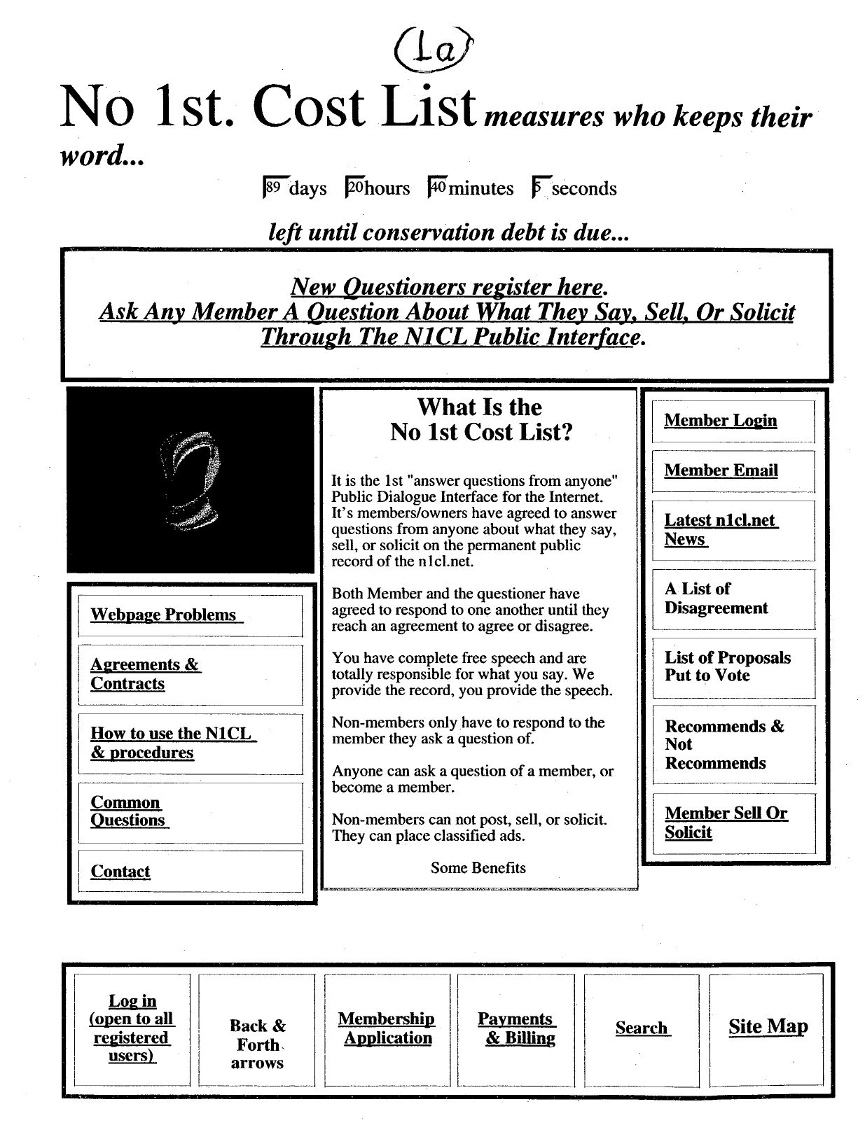

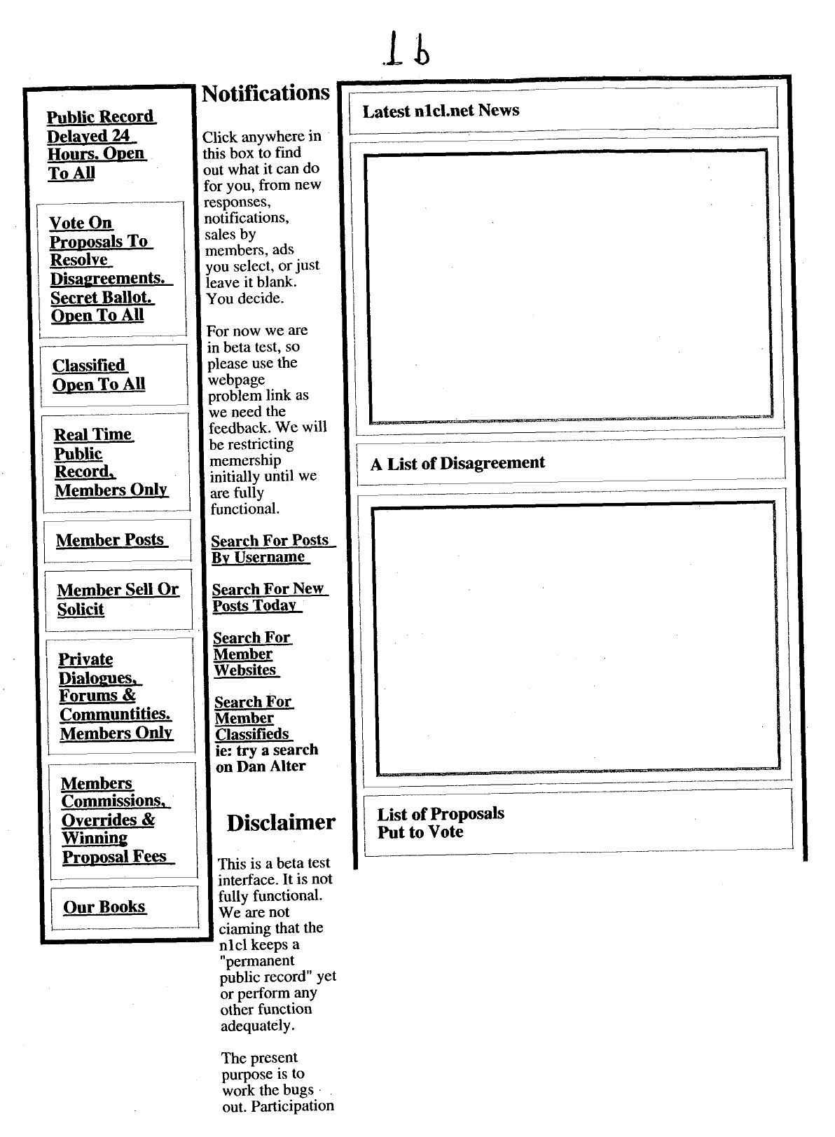

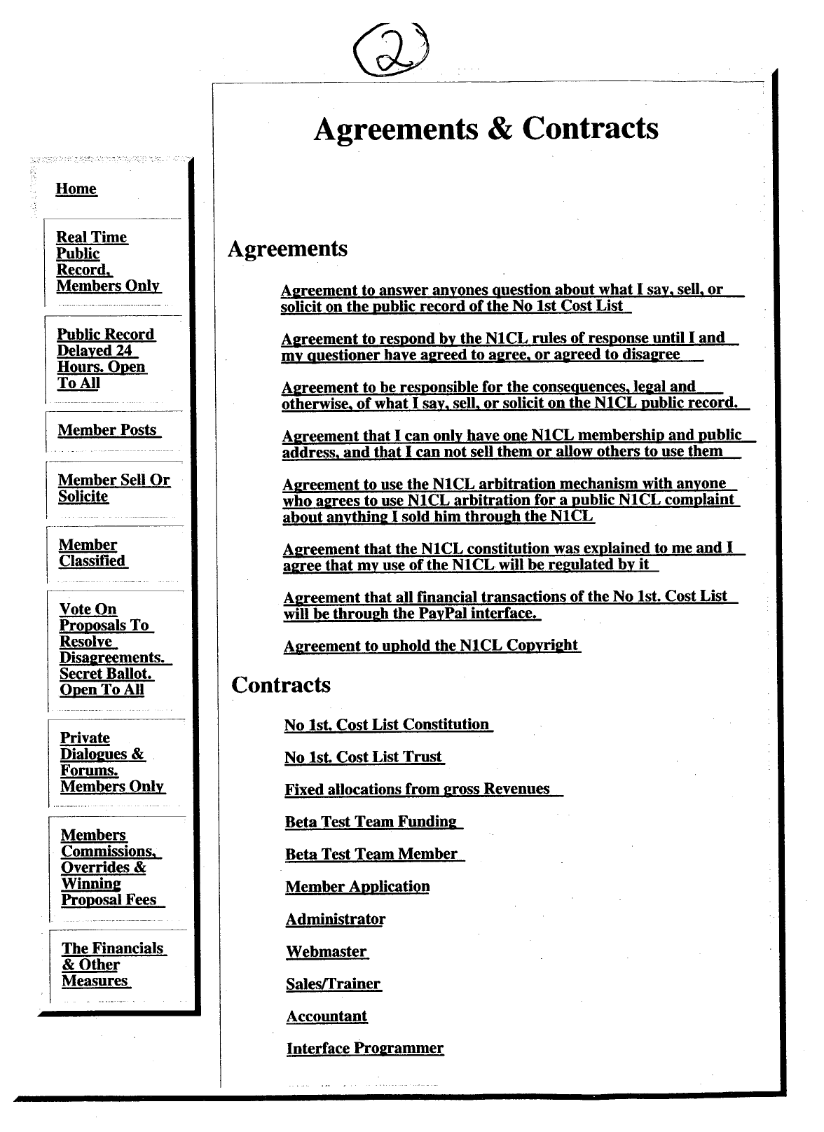

FIG. 3—Additional Embodiments

An additional embodiment is shown by the 2nd web-site button in the lower lefthand column of the n1cl web page 1b labeled “Vote on Proposals to Resolve Disagreements. Secret Ballot. Open to All.”. This use can only exist after disagreements are identified in public.

Another embodiment is the N1CL News which reports the disagreements identified on the No !st Cost List and other news reports by members who, of course, have agreed to respond to questions about their reports.

Advantages

From the description above, a number of advantages for our ‘universal information exchange’ become evident:

(a) A massive reduction in the cost of verifying logical and observational discrepancies in scientific theories: With a central meeting place to register disagreements with present scientific theories and models, the scientific journals that use anonymous referees and peer reviews to block disagreements with existing theories will have to change their ways.

(b) The clear sharp boundary between Public and private exchanges of information: Until we have a clear structural definition of a public place for the exchange of all ideas and information, we can not, in practice, clearly define privacy over the Internet. Our political liberties rest upon the ability to exchange and vet controversial criticisms privately before subjecting them to the fire of open to all public criticism. The need for privacy for other business and personal uses is obvious. Real liberty implies real privacy.

(c) Veracity, how do you prove it? The only real way I can think of is be willing to open yourself up to public criticism from everyone. This enables any of us who want to, to do so; especially anyone who claims to be a scientist; our stated purpose demands no less.

(d) Protect oneself against unjust or false accusations. The N1CL lets people defend themselves against false and unjust public accusations, which under our present system are often very expensive to challenge. Eventually the existence of the N1CL will force an accuser to speak on the record where they can be challenged and forced to respond. With it we can both prove our veracity and protect ourselves against unjust accusations.

(e) Catches public problems while they are still small.

(f) A universal message tree. Everyone of us at some time has lost contact with someone else and wished they had agreed on a single place they could both go to re-establish contact. This creates a single place we can meet 24/7.

(g) A list of previously answered questions in one place. What an economy for businesses. After a period of time, businesses will accumulate answers to almost all conceivable questions from “hours of operation” to “who does what” to “where are you at”, in one place, saving everyone the pain of endless phone menus and businesses the time spent answering many repetitive questions. Which creates a;

(h) New kind of “Yellow Pages”, that can really explain what a business does through its own self-created list of answers to its customers and others questions.

(i) A permanent. central memory for our civilization.

These are some advantages created by a No 1st Cost List, there are more, and many more will be realized through actual use by its members and users.

Operation—see Web Pages 1a & 1b and Specifications Listed in PPA

The operation of the N1CL interface is neatly divided into two areas:

The member/user and the building and the control and administration of the interface. Both sides meet at the web-site. For a member/user, it starts with an application for membership and proceeds until their ID is verified and their N1CL public address is permanently granted. After they are a member they answer questions that start public dialogues and the other members only features of the N1CL.

Non-members only have to have a valid e-mail address and agree to the Rules of Response. They can not answer questions from anyone but the member who is party to their dialogue.

The actual mechanics of use are similar to other web-sites and need not be addressed here. Other uses can be seen on the web site at n1cl.net.

Controlling the building, maintaining, and administering of the interface are crucial. The two tests of success that show when we are successful in completing the building of the interface are:

First, after it is completed and in operation, that it treat its builders, present owner and inventors and anyone who works for it are treated by the Interface exactly the same as any other member/user.

Second, this requires that its rules be enforced automatically by software and mechanical design, so that any human intervention is only to fix human or “mechanical” errors.

These two above tests require that we have:

(a) A constitution that prescribes how the members will control the interface in the future and that which describes which aspects of the interface can not be changed. For example, members can not sell or transfer their membership or sell or transfer the ownership of the N1CL from its members in perpetuity. A first constitutional draft is done and we will haggle about it in Beta.

(b) A buy/sell agreement to transfer ownership from the inventor/owners to the members.

(c) A patent to protect the unique basis of the N1CL, ‘the agreements to respond until we reach an agreement to agree or disagree’, until it is fully functional.

(d) A published plan for building, operating, and transferring ownership of the N1CL to its members. See Invention Disclosure, PPA, RPA, and n1cl.net.

(e) An agreement by member/owners that they will maintain the “specs” of the N1CL in perpetuity resolving disagreements on a one member one vote basis.

Conclusion, Ramifications, and Scope

Conclusion: A long sought unconscious ideal is now physically possible to invent. A single place where all of us can meet on an equal basis 24/7 from anywhere we can reach to, and communicate back from, in the universe is now being built. It will cause a political, scientific, and economic revolution.

Ramifications: This lowers the cost of exchange in many areas by orders of magnitude. This implies an economic flowering for the whole planet.

The next consequence is scientific, by publicly discussing our theoretical disagreements in real time means an enormous increase in scientific advances in many areas. We thought science was advancing rapidly, it is going to go a lot faster.

The first political consequence is that the N1CL will be used by us to ask our governments to explicitly vote that these two words define what a crime is: Striking First. All our legal systems past and present already assume these two words to define what a crime is. We all know these two words define what a crime is unconsciously, no one likes to be struck first. We just haven't agreed out loud for the whole planet. Once we do, then we can call ourselves civilized.

The name: No 1st Cost List was picked in 1985 because it directly reflects the fundamental discovery I made. i.e. What the fundamental objective measure of value all life forms. use and how we use it. Not liking being struck first is a direct implication.

Many other specific ramifications have been discussed in the specifications, features and advantages listed above. However, I suspect it will have many complex and surprising effects that are beyond my ability to predict for now.

Scope: A planet-wide universal impact in all areas where we exchange information, ideas, and exchange goods and services by greatly reducing the cost of verifying information we rely on to conduct our exchanges.

This is truly a new invention that has never before existed. It will fundamentally affect all of us and our relationships to each other.

Thus the scope of this invention should be determined by the appended claims and their legal equivalents, rather than by the examples given.

1. A “No 1st Cost List” is a privately owned Public Internet Interface for universal information exchange that uses Disagreement Dialogues to identify any questions and disagreements about the information and goods & services exchanged through the Internet Interface, comprising;
(a) an Internet web-site named the No !st Cost List(n1cl.com),
(b) open to all on an equal basis,
(c) no prior restraint on speech,
(d) an agreement by this Interface's members to answer questions from anyone about what they say, sell, or solicit, or place on the public record of this Interface,
(e) an agreement by anyone who asks questions of a member to respond to the member until both parties to the dialogue agree to agree or disagree,
(f) an agreement by the member to respond to the questioner until they reach an explicit agreement to agree or disagree,
(g) an agreement by both parties to a dialogue to abide by the pre-defined Rules of Response and accept the automatic consequences of violating these Rules of Response,
(h) software that automatically enforces the constraints defined by the agreements above upon any parties to the dialogues that violate the Rules of Response,
(i) the computers, databases, memory, and software needed to remember, track, and automatically remind parties to dialogues whose turn it is,
(j) it will be owned, regulated, and exclusively controlled by its members users, who have agreed to maintain it to “specs” listed in the N1CL constitution, application, and agreements, on a one member one vote basis,
the improvement wherein said Public Internet Interface for universal information exchange has never been done before, nor have such procedural agreements enforced by software design been used in an open to all Public Internet Interface for universal information exchange on the Internet before.

2. A Public Internet Interface for universal information exchange of claim 1. can be modified in the following manner:
(a) a Dialogue can be conducted by subsets of all possible users, e.gs. all members of a union, or all men and women over age 25 can conduct Dialogues using all elements (a) through (h) except that (b) is modified to “open to a (pre-defined x characteristics kind of persons) on an equal basis.
(b) these sub-set dialogues can be conducted in public or private.

3. A Public Internet Interface for universal information exchange of claim 1. can be modified in the following manner:
(a) use disagreements identified on the N1CL public record to,
(b) let persons make proposals on the public record of the N1CL to resolve said disagreements,
(c) by using an anonymous paid voting mechanism that decides proposals,
(d) takes proceeds from voting awards them to winning side by dividing them by a pre-determined formula among the proposers, parties to the disagreement and authors of reasons given by voters.
